(19) United States
(12) Patent Application Publication
(10) Pub. No.: US 2023/0239136 A1
(43) Pub. Date: Jul. 27, 2023

(54) Pipelined Galois Counter Mode Hash Circuit

(71) Applicants: Sergey Vladimirovich Gribok, Santa Clara, CA (US); Gregg William Baeckler, San Jose, CA (US); Bogdan Pasca, Toulouse (FR); Martin Langhammer, Alderbury (GB)

(72) Inventors: Sergey Vladimirovich Gribok, Santa Clara, CA (US); Gregg William Baeckler, San Jose, CA (US); Bogdan Pasca, Toulouse (FR); Martin Langhammer, Alderbury (GB)

(21) Appl. No.: 18/129,709

(22) Filed: Mar. 31, 2023

Related U.S. Application Data
(60) Provisional application No. 63/429,115, filed on Nov. 30, 2022.

(51) Int. Cl. H04L 9/06; H04L 9/32

(52) U.S. Cl. CPC H04L 9/0637; H04L 9/3242

(57) ABSTRACT

Integrated circuits, methods, and circuitry are provided for performing multiplication such as that used in Galois field counter mode (GCM) hash computations. An integrated circuit may include selection circuitry to provide one of several powers of a hash key. A Galois field multiplier may receive the one of the powers of the hash key and a hash sequence and generate one or more values. The Galois field multiplier may include multiple levels of pipeline stages. An adder may receive the one or more values and provide a summation of the one or more values in computing a GCM hash.

### CROSS-REFERENCE TO RELATED APPLICATIONS

This application claims priority to U.S. Provisional Application No. 63/429,115, filed Nov. 30, 2022, entitled “Pipelined GCM Hash Circuit,” the disclosure of which is incorporated by reference in its entirety for all purposes.

### BACKGROUND

This disclosure relates generally to encryption or decryption on an integrated circuit (IC) device such as a programmable logic device (PLD) or application specific integrated circuit (ASIC) for secure communication.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

New secure communication devices and applications may use authenticated encryption with associated data. At times, multiple channels with separate circuits for respective channels may be used. For security, all the circuits may be physically and logically separate. Because the encryption or decryption calculation is recursive, individual hash functions may not be pipelined. Further, an integrated circuit system designed to perform encryption or decryption may suffer from issues related to speed and timing closure due to not being able to pipeline the critical path in a hash calculation. With many (e.g., 64 or more) separate circuits for the respective channels, current field programmable gate arrays (FPGAs) may not be able to support system designs suitable to perform encryption or decryption for a large number of channels of secure communication.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is an example GCM hash operation, in accordance with an embodiment of the present disclosure;

FIG. 4 is a block diagram of a non-pipelined hash circuit, in accordance with an embodiment of the present disclosure;

FIG. 5 is a block diagram of an example of a polynomial multiplication portion and a modular reduction portion of a multiplier of FIG. 4, in accordance with an embodiment of the present disclosure;

FIG. 6 is a block diagram of a parallel hash circuit, in accordance with an embodiment of the present disclosure; and

FIG. 7 is a block diagram of a GCM pipelined hash circuit, in accordance with an embodiment of the present disclosure;

FIG. 8 is a representation of the reduction of four scalar multiplications to three scalar multiplications using the Karatsuba-Ofman (K-O) algorithm, in accordance with an embodiment of the present disclosure

FIG. 9 is a simplified block diagram of a three-level decomposition of a polynomial multiplier, in accordance with an embodiment of the present disclosure;

FIG. 10 is a block diagram of the three-level decomposition of the polynomial multiplier displaying additional addition operations, in accordance with an embodiment of the present disclosure;

FIG. 11A is an illustration of the arrangement of the additional addition operations for one decomposition leaf of FIG. 10, in accordance with an embodiment of the present disclosure;

FIG. 11B is an illustration of a multicycle architecture based on one decomposition leaf of FIG. 10, in accordance with an embodiment of the present disclosure;

FIG. 12 is an illustration of the assembly of the resulting product as described with respect to FIG. 11, in accordance with an embodiment of the present disclosure;

FIG. 13 is a block diagram of a two-cycle three-level decomposition of the polynomial multiplier, in accordance with an embodiment of the present disclosure;

FIG. 14 is a block diagram of a right portion of the two-cycle three-level decomposition of the polynomial multiplier as described with respect to FIG. 13, in accordance with an embodiment of the present disclosure;

FIG. 15 is a block diagram of a left portion of the two-cycle three-level decomposition of the polynomial multiplier as described with respect to FIG. 13, in accordance with an embodiment of the present disclosure;

FIG. 16 is an additional embodiment of the polynomial multiplier of FIG. 10, in accordance with an embodiment of the present disclosure;

FIG. 17 is a block diagram of a cut point in the additional embodiment of the polynomial multiplier of FIG. 10, in accordance with an embodiment of the present disclosure; and

FIG. 18 is a block diagram of a right portion of the additional embodiment of the polynomial multiplier of FIG. 10, in accordance with an embodiment of the present disclosure.

FIG. 19 is a block diagram of a data processing system that may incorporate the integrated circuit, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As previously noted, new secure communication device use multiple channels with separate circuits to perform authenticated encryption or decryption. With this in mind, the present systems and methods relate to embodiments for a pipelined Galois counter mode (GCM) hash circuit. In the pipelined GCM hash circuit, a hash sequence is refactored to decompose into a sum of a number of independent hash sequences. Each of the independent hash sequences may occupy a different pipeline within the pipelined GCM hash circuit. Further, each of the independent hash sequences may be calculated to respectively return a hash value. Subsequently, the respective hash value from each of the independent hash sequences may be added in an external shift register. When the respective hash values have been added, the hash value may then be multiplied by a final value, thus using the pipelined GCM hash circuit in a multi-cycle mode rather than a pipelined mode. It should be noted that the pipelined design of the authentication portion of the GCM circuit may also be applicable to other type of operation involving Galois field multiplication over large fields.

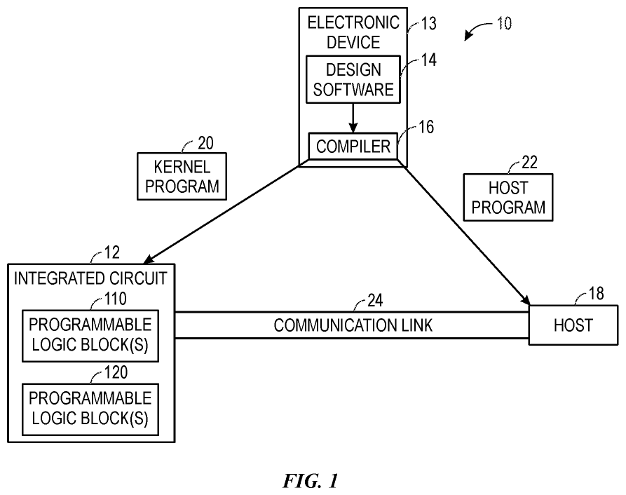

With this in mind, FIG. 1 illustrates a block diagram of a system 10 that may implement arithmetic operations using a digital signal processing (DSP) block. A designer may desire to implement functionality such as, but not limited to, computation of cryptographic functions, on an integrated circuit device 12 (e.g., such as a field-programmable gate array (FPGA) or an application-specific integrated circuit (ASIC)). In some cases, the designer may specify a high-level program to be implemented, such as an OpenCL program, which may enable the designer to more efficiently and easily provide programming instructions to configure a set of programmable logic cells for the integrated circuit device 12 without specific knowledge of low-level hardware description languages (e.g., Verilog or VHDL). For example, because OpenCL is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designers may implement their high-level designs using design software 14, such as a version of Intel® Quartus® by INTEL CORPORATION. The design software 14 may use a compiler 16 to convert the high-level program into a lower-level description. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of one or more DSP blocks 26 on the integrated circuit device 12. The DSP block 26 may include circuitry to implement, for example, operations to perform matrix-matrix or matrix-vector multiplication for AI or non-AI data processing. The integrated circuit device 12 may include many (e.g., hundreds or thousands) of the DSP blocks 26. Additionally, DSP blocks 26 may be communicatively coupled to another such that data outputted from one DSP block 26 may be provided to other DSP blocks 26.

While the techniques above discussion described to the application of a high-level program, in some embodiments, the designer may use the design software 14 to generate and/or to specify a low-level program, such as the low-level hardware description languages described above. Further, in some embodiments, the system 10 may be implemented without a separate host program 22. Moreover, in some embodiments, the techniques described herein may be implemented in circuitry as a non-programmable circuit design. Thus, embodiments described herein are intended to be illustrative and not limiting.

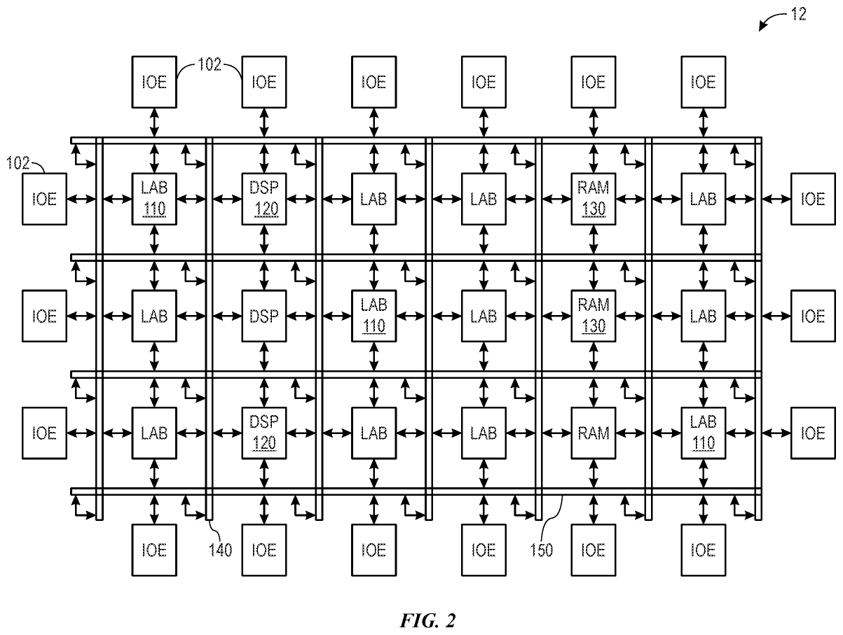

Turning now to a more detailed discussion of the integrated circuit device 12, FIG. 2 illustrates an example of the integrated circuit device 12 as a programmable logic device, such as a field-programmable gate array (FPGA). Further, it should be understood that the integrated circuit device 12 may be any other suitable type of integrated circuit device (e.g., an application-specific integrated circuit and/or application-specific standard product). As shown, the integrated circuit device 12 may have input/output circuitry 42 for driving signals off device and for receiving signals from other devices via input/output pins 44. Interconnection resources 46, such as global and local vertical and horizontal conductive lines and buses, may be used to route signals on integrated circuit device 12. Additionally, interconnection resources 46 may include fixed interconnects (e.g., conductive lines) and programmable interconnects (e.g., programmable connections between respective fixed interconnects). Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of the programmable logic 48.

Programmable logic devices, such as integrated circuit device 12, may contain programmable elements 50 within the programmable logic 48. For example, as discussed above, a designer (e.g., a customer) may program (e.g., configure) the programmable logic 48 to perform one or more desired functions. By way of example, some programmable logic devices may be programmed by configuring their programmable elements 50 using mask programming arrangements, which is performed during semiconductor manufacturing. Other programmable logic devices are configured after semiconductor fabrication operations have been completed, such as by using electrical programming or laser programming to program their programmable elements 50. In general, programmable elements 50 may be based on any suitable programmable technology, such as fuses, antifuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using pins 44 and input/output circuitry 42. In one embodiment, the memory cells may be implemented as random-access-memory (RAM) cells. The use of memory cells based on RAM technology is described herein is intended to be only one example. Further, because these RAM cells are loaded with configuration data during programming, they are sometimes referred to as configuration RAM cells (CRAM). These memory cells may each provide a corresponding static control output signal that controls the state of an associated logic component in programmable logic 48. For instance, in some embodiments, the output signals may be applied to the gates of metal-oxide-semiconductor (MOS) transistors within the programmable logic 48.

Keeping the foregoing in mind, the DSP block 26 along with programmable logic 48 discussed herein may be used to perform many different operations associated with the cryptographic applications. Thus, the programmable logic circuits used for such applications may include embedded DSP blocks 26 and/or programmable logic 48. Where same elements appear in multiple drawings, like numbers refer to like elements and may not be described more than once.

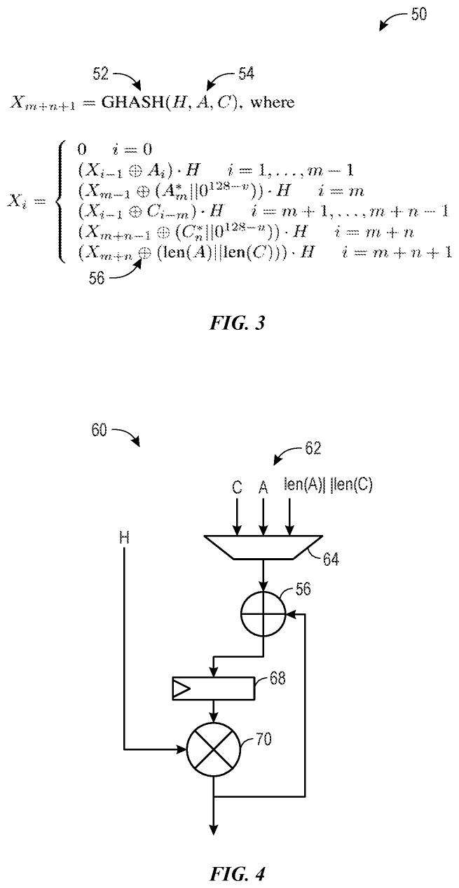

FIG. 3 is an example GCM hash operation 50 that may be carried out using the integrated circuit 12. The GCM hash operation 50 may include a GHash function 52 that may take a triplet 54 (e.g., H, A, and C), where H may be considered a hash key and A (e.g., additional authenticated data) and C (e.g., ciphertext) may be input values. The calculation of an authentication hash is iterative through a multiplier. In the illustrated equation, the GCM hash operation 50 is an iterative algorithm that continues for values of i incrementing from 1 to m+n+1. On every iteration, multiplication is performed as well as an exclusive-or (XOR) operation 56 on the current result with one of the input structures (e.g., as illustrated here, A or C). The XOR operation 56 may be carried out as the bitwise addition of two-bit strings of equal length.

Further, a resulting value is multiplied by the hash key (H). As shown in FIG. 3, the GCM hash operation 50 may operate on a large field (e.g., 128 bits), which may entail the use of a large multiplier. Therefore, the propagation delay could be long, thus resulting in a low clock speed, which in turn impacts the throughput of the hash value. As mentioned above, the GCM hash core may not be pipelined using known methods due to the recursive nature of the calculation.

A recursive path can be expanded using Horner's rule according to Equation 1 below:

((((A₁H+A₂)H+A₃)H+A₄)H+A₅)H+ . . . Equation 1

By taking a short sequence of six values according to Equation 2 below:

(((((A₁H+A₂)H+A₃)H+A₄)H+A₅)+A₆)H Equation 2

We can refactor Equation 2 into Equation 3 as shown below:

(((A₁H²+A₃)H²+A₅)H²+(((A₂H+A₄)H+A₆)H Equation 3

Therefore, the sequence may be expressed using two separate hash sequences. As such, the value of H² may be calculated before proceeding with the multiplication, which is a single Galois field multiply. Additionally, the basic sequence may be refactored into any number of parallel sequences. As an example, Equation 4 is shown below:

((A₁H⁴+A₅)H⁴+A₉)H⁴+((A₂H³+A₆)H³+A₁₀)H³+((A₃H²+A₇)H²+A₁₁)H²+(((A₄H+A₈)H+A₁₂)H Equation 4

FIG. 4 is a block diagram of a non-pipelined hash circuit 60 of FIG. 3. Input values A, C, and len(A) concatenated with len(C) may be input into selection circuitry 64. The len(A) is a bit length of a bit string A and len(C) is the bit length of a bit string C. Each value may be selected using the selection circuitry 64. Thereafter, the XOR operation 56 may be performed on each selected input value with the previous value. Indeed, the values are input into a running hash sequence and stored in a register 68. The authentication mechanism within the GCM hash operation is based on a hash function that features multiplication by a fixed parameter, called the hash key (H), within a binary Galois field. After the value of the XOR operation 56 is determined, the next iteration is calculated by multiplying the hash key (H) in a Galois field multiplier 70. The resulting value is then returned back into the XOR operation 56 to perform the XOR operation 56 with the previously determined resulting value.

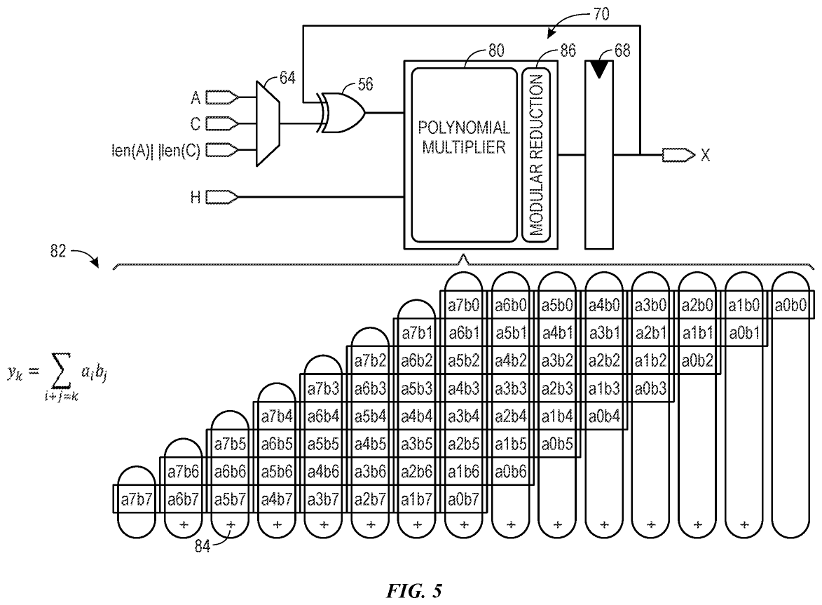

FIG. 5 is a block diagram of an example of a polynomial multiplication portion and a modular reduction portion of the multiplier of FIG. 4, in accordance with an embodiment of the present disclosure. Polynomial modular multiplication of the Galois field multiplier 70 has two parts, namely, a polynomial multiplication part and a modular reduction part (sometimes also referred to as multiplicative expansion and division reduction). Therefore, the Galois field multiplier 70 may contain circuitry for a polynomial multiplier 80 and circuitry for modular reduction 86.

FIG. 5 provides an example of partial products 82 of the polynomial multiplier 80. In the illustrated example, two input values, A and B, may be multiplied in pairs from a0b0 to a7b7. However, it should be noted that any n-bit values may be used in the polynomial multiplier 80. As shown, the polynomial multiplier 80 is 128-bit x 128-bit but may take any other suitable size in other examples. Thus, when the polynomial multiplier 80 is 128-bit x 128-bit, the result will be 128 partial products 82. Further, each partial product 82 may be offset by one bit. The XOR operation 56 may be performed on each value of each column of the partial products 82 to obtain a product, which may be 256 bits. After the product is obtained, the modular reduction 86 may begin to reduce the product to 128 bits.

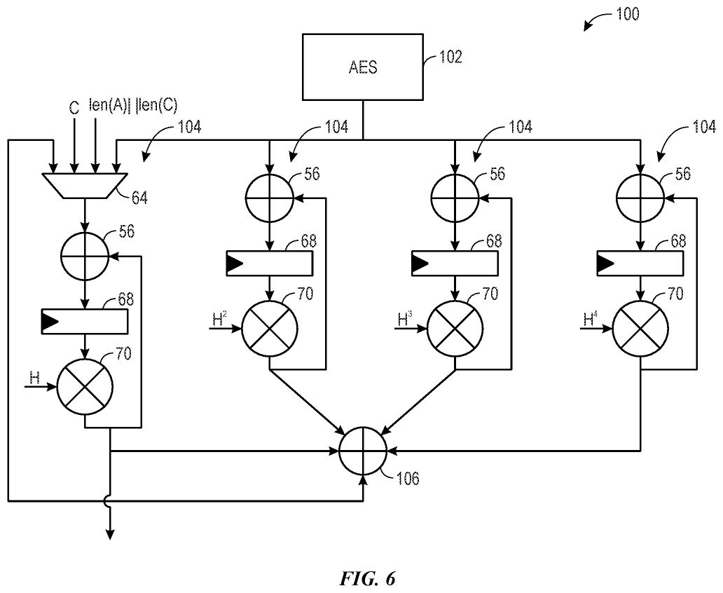

FIG. 6 is a block diagram of a parallel hash circuit 100 that may be implemented on the integrated circuit 12. The GCM hash operation 50, as described above, may also be refactored into any suitable number of parallel sequences. Thus, the parallel hash circuit 100 may be implemented for performing parallel computation. In the example of FIG. 6, an encryption core 102 may feed into each of four branches 104 (e.g., hash cores), allocating equal amounts of time to each of the four branches 104 in a circular manner, but other examples may include more or fewer branches. As such, the XOR operation 56 may be performed on each respective input passing through each branch 104 to obtain the hash sequence. The hash sequence may then be stored in the respective register 68 of the branch. Additionally, each branch 104 may involve multiplication by a different constant (e.g., different powers of the hash key value H) at the Galois field multiplier 70. Each branch 104 may run at one-fourth the speed of the encryption core 102, which may be pipelined.

After each sequence of each of the four branches 104 is calculated, the four sequences may be added together using an additional XOR operation 106. The added value may then be input into one of each of the four hash cores to complete processing using the remaining C value and the length of data. While this core may run four times the speed of the standard core in FIG. 1, it may also be four times as large. It should be noted that while the encryption core 102 is shown as an advanced encryption standard (AES) core, any suitable encryption core may be used.

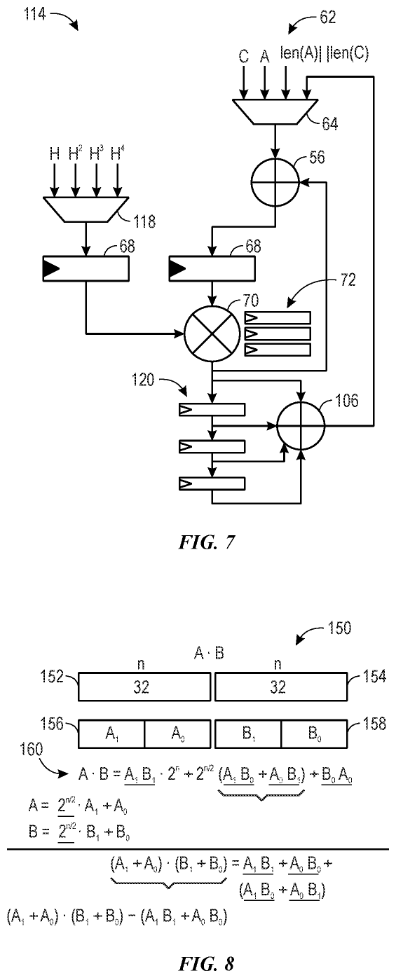

FIG. 7 is a block diagram of a GCM pipelined hash circuit 114 that may be implemented in the integrated circuit 12. In the GCM pipelined hash circuit 114, the circuit may be decomposed by taking common factors (e.g., powers of the hash key H) and expressing the common factors in different powers of the hash key. Therefore, a different term may be calculated during every clock cycle.

As mentioned above, input values A, C, and len(A) concatenated with len(C) may be input into selection circuitry 64. Thereafter, the XOR operation 56 may be performed on each selected input value with the previous value to obtain a hash sequence. The hash sequence is then stored in the register 68. The hash sequence is fed into a single pipelined Galois field multiplier 70. Simultaneously, a corresponding power of the hash key may be multiplexed into the single pipelined Galois field multiplier 70. The resulting values from the pipelined Galois field multiplier 70 may be stored in registers 72 to enable pipelining of the Galois field multiplier 70.

In the illustrated example, there are four powers of the hash key. Therefore, four separate partial hash sequences may exist in the Galois field multiplier 70 pipelines at the same time. The four separate partial hash sequences may also be streamed into a delay chain 120. The additional XOR operation 106 (e.g., addition) may be performed on the four partial separate hash sequences to obtain a single hash value. The single hash value, which is the summation of the four separate partial hash sequences, may be a correct running hash at a given clock cycle.

The summation may be fed back into the Galois field multiplier 70, where it may be added to the input value C, and the len(A) concatenated with len(C). A state machine may control the two previously discussed calculations as each iteration goes through each pipeline stage of the Galois field multiplier 70 (e.g., the last two iterations are latched every four-clock cycles). In this manner, the hash sequence is refactored to decompose it into the sum of several independent hash sequences. The several independent hash sequences are iterated in the pipelined Galois field multiplier 70. Further, the running hashes are summed in the registers 72. Indeed, when complete, the summed sequences may be multiplied by the Galois field multiplier 70 in a multi-cycle rather than a pipelined mode. It should be noted that while the pipelined depth of the GCM pipelined hash circuit 114 as illustrated in FIG. 7 is four, the pipelined depth may be any suitable number.

FIG. 8 is a representation of the reduction of four scalar multiplications to three scalar multiplications using the K-O algorithm. In the illustrated example, inputs A and B 150 may be multiplied. A multiplier within the hardware may be operating using (n/2)+1 bits. Inputs A and B 150 may each be n bits. As shown, A and B are 32 bits but may take any other suitable size in other examples. Therefore, a 32-bit x 32-bit value may be multiplied in FIG. 8. The multiplier may not support 32-bit x 32-bit multiplication; thus, each block (e.g., 152 and 154) may be split into two blocks of 16 bits each when the multiplier supports values of at least 16 bits. The split A block 156 may result in A₁A₀ and the split B block 158 may result in B₁B₀. A product 160 of A and B has coefficients according to Equation 5 below:

A·B=A₁B₁(2ⁿ)+(2^{n/2})(A₁B₀+A₀B₁)+A₀B₀ Equation 5

The middle terms A₁B₀+A₀B₁ may be expressed as shown in FIG. 8 and according to Equation 6 below:

(A₁B₀+A₀B₁)=(A₁+A₀)(B₀+B₁)−(A₁B₁+A₀B₀) Equation 6

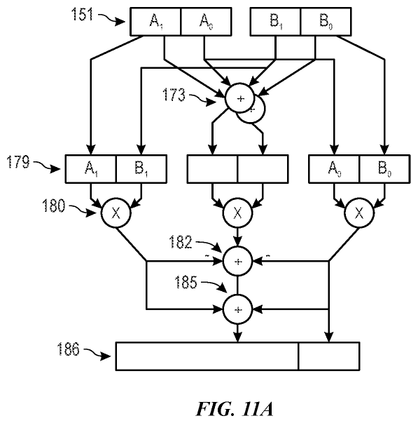

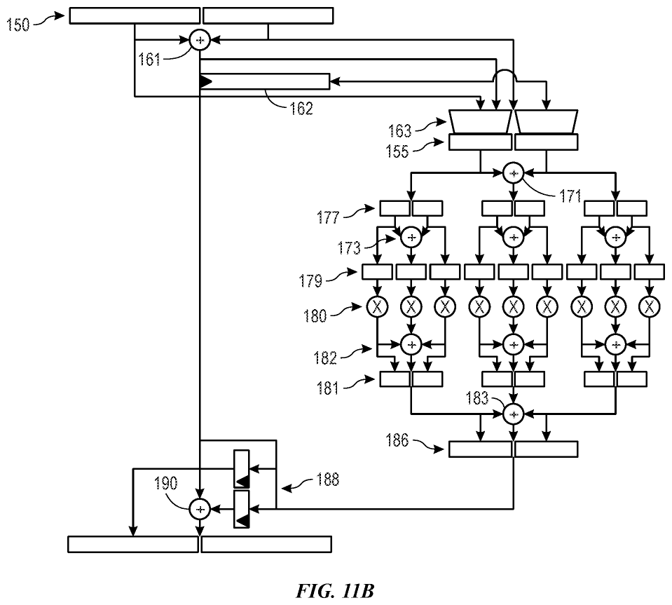

As observed in Equation 5, A₁B₁, A₀B₀ have already been computed. Thus, a product of A and B 160 is able to be expressed using three scalar multiplications as shown in FIG. 11A and according to Equation 7 below:

A·B=A₁B₁2ⁿ+2^{n/2}((A₁+A₀)(B₀+B₁)−(A₁B₁+A₀B₀))+A₀B₀ Equation 7

As mentioned above, the reduction from four scalar multiplications in Equation 5 to three scalar multiplications in Equation 7 is the K-O algorithm. The K-O algorithm may then be recursively applied on the three scalar multiplications. In this manner, the three scalar multiplications may be further decomposed recursively.

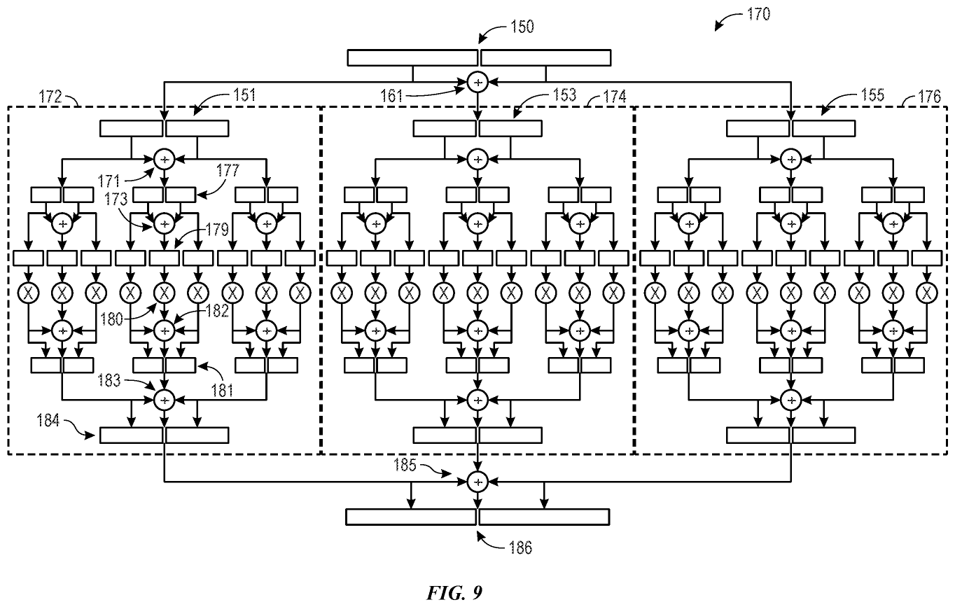

FIG. 9 is a simplified block diagram of a three-level decomposition of a multiplier 170. The multiplier 170 may be separated into a left decomposition leaf 172, a middle decomposition leaf, 174, and a right decomposition leaf 176. Each of the three decomposition leaves (e.g., 172, 174, or 176) may correspond to the multiplication shown above as well as in FIG. 8. At each of the three decomposition leaves (e.g., the three leaf nodes), the inputs A and B 150 may be received. The inputs A and B 150, are then split into high and low parts A₁A₀, B₁B₀ (as shown in FIG. 8), which may be added via an addition operations 161 (A₁+A₀) and (B₁+B₀). At the left decomposition leaf 172 a first input 151 may be received. Further, at the middle decomposition leaf 174 a second input 153 may be received. Even further, at the right decomposition leaf 176 a third input 155 may be received. In the KO-algorithm implementation, there are addition operations (e.g., adders) 171 and 173 before the multiplication operation (multipliers) 180. The addition operation 171 (pair of additions or the form (A₁+A₀) and (B₁+B₀)) may result in a first set of sums 177 and after passing through the addition operations 173, a second set of sums 179. The second set of sums 179 may then be input into the multiplication operation 180, and then an additional addition operation (e.g., additional adder) 182 sums the products produced by multipliers 180 to produce a product 181 corresponding to multiplying inputs 177. The product 181 may then be received by an additional addition operation 183 to produce resulting values 184—which correspond to multiplying inputs 151. The resulting values 184 may be received by an additional addition operation 185 to assemble an output 186 of multiplying inputs 150.

In an approach, one of the three decomposition leaves (172, 174 or 176) may be selected to perform the multiplication described in FIG. 8. The one decomposition leaf selected may then be used three times and the product may be assembled (e.g., added) together after the three multiplications have been performed. Subsequently, should a single hardware component capable of executing the three decomposition leaves 172, 174 or 176 be present, one may need to iterate over three times to get the resulting values 184 (each iteration sequentially executes, in no particular order, 172, 174, and 176). The resulting values 184 may then be assembled together to receive the output 186. However, a one-third throughput resulting from the one-third implementation of the multiplier 170 may not provide the appropriate ratio between resource utilization and throughput.

In another approach, the multiplier 170 may be implemented as shown, where a result is produced per clock cycle. This would produce the highest throughput, but also uses the most hardware resources to implement. It should be noted that although FIG. 9 depicts the addition operation 182 in singular form, there may be additional addition operations performed, that are omitted from FIG. 9 for the sake of clarity. An example of such an implementation where these supplemental addition operations are explicitly shown will be discussed below.

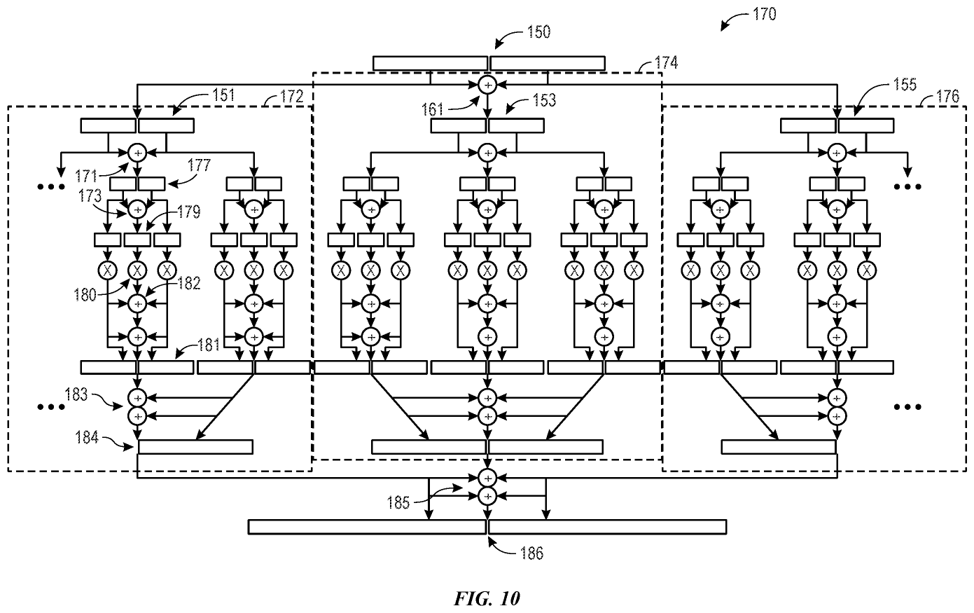

FIG. 10 is a block diagram of the three-level decomposition of the multiplier 170 displaying the additional addition operation 182, in accordance with an embodiment of the present disclosure. As mentioned above, at each of the three decomposition leaves, sections of the inputs A and B 150 may be multiplied. For instance, inputs 151 may correspond to A₁B₁, 155 may correspond to A₀B₀, and inputs 153 may correspond to (A₁+A₀)(B₁+B₀). The resulting values 184 may then be assembled together via the additional addition operations 185 to produce the output 186. As illustrated, there are addition operations 171 before the multiplication operation 180, and two additional addition operation 182 following the multiplication operation 180.

FIG. 11A is an illustration of the arrangement of the additional addition operation 182 for one decomposition leaf of FIG. 10, in accordance with an embodiment of the present disclosure. As shown, inputs A and B 151 are split into two limbs each: A₁ and A₀, B₁ and B₀ respectively. The left and right multipliers 180 may output products A₁B₁ and A₀B₀ respectively. The adder pair 173 produces the sums A₁+A₀ and B₁+B₀ which are then fed into the middle multiplier 180. The additional addition operation 182 produces the sum (A₁+A₀)(B₁+B₀)−A₁B₁−A₀B₀, which corresponds to term weight 2^{n/2} in Equation 7. Additionally, it should be noted that the side inputs of the additional addition operations 182 correspond to negated values of the corresponding inputs. Finally, the additional addition operation 185 sums the weighted terms of Equation 7. The bottom n/2 bits of the product A₀B₀ are directly fed into the bottom n/2 bits of the output 186. The additional addition operation 185 sums:

$${A}_{1} {B}_{1} {2}^{\frac{n}{2}} + ( ( {A}_{1} + {A}_{0} ) ( {B}_{0} + {B}_{1} ) - ( {A}_{1} {B}_{1} + {A}_{0} {B}_{0} ) ) + ( {A}_{0} {B}_{0} ≫ \frac{n}{2} ) .$$

FIG. 11B is an illustration of a multicycle architecture based on leaf 174 of FIG. 10. The architecture schedules the three decomposition leaves 172, 174, and 176 onto a single leaf multiplier hardware. The scheduling order is the decomposition leaf 176 is executed in the first clock cycle, the decomposition leaf 174 is executed in the second clock cycle and the decomposition leaf 172 is executed in the third clock cycle. During the first cycle the input sections A₀ and B₀ are selected using selector circuitry 163 and are routed to the inputs 155 to generate product A₀B₀ at the output 186, which is then stored in register circuitry 188. As disclosed herein, the inputs A and B 150 may also need to be added at the addition operation (e.g., adder) 161 to produce the inputs of the middle multiplier 174. Two sums may be produced: (A₁+A₀) and (B₀+B₁). The first sum (A₁+A₀) may be produced in the first clock cycle and stored for one cycle in register 162. In the second cycle, the addition operation 161 produces the second sum (B₀+B₁). The previously registered sum (A₁+A₀) from register 162 and the newly computed sum (B₀+B₁) are then selected by the selector circuitry 163 to be routed to the inputs 155 to generate the product (A₁+A₀)(B₀+B₁) at the output 186. During the same cycle (e.g., the second cycle), the addition operation 190 performs subtraction (A₁+A₀)(B₀+B₁)−A₀B₀ between the current product and the previously generated product which may again be stored into the register circuitry 188. At clock cycle three, the selector circuitry 163 routes A₁ and B₁ to the inputs 155 of the multiplier block to generate product A₁B₁ at the multiplier output 186. The adder 190 may be configured again as a subtractor to subtract the newly computed product A₁B₁ out of (A₁+A₀)(B₀+B₁)−A₀B₀, which is stored in the register circuitry 188. The bottom half of the registered product A₀B₀ is routed to the output. Further, the top half of this product is concatenated to the right of the product A₁B₁. The newly created signal may be fed alongside the newly created middle term ((A₁+A₀)(B₀+B₁)−A₀B₀−A₁B₁) into the addition operation 190 or may reuse unutilized adder circuitry. The returned sum may then be routed to the output.

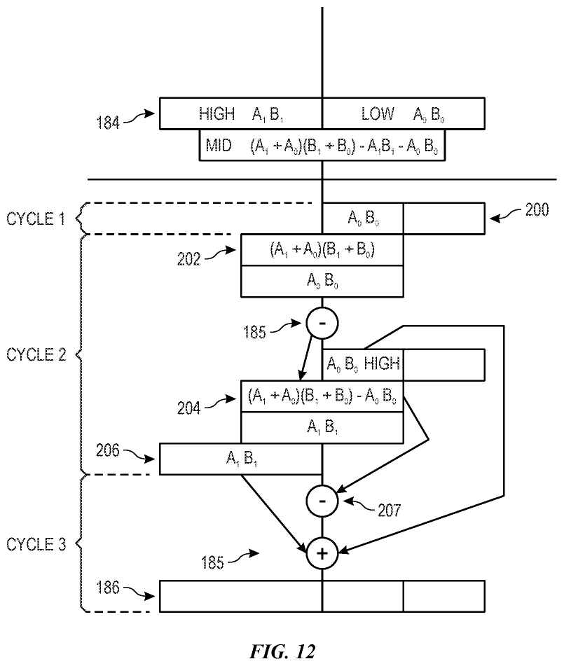

FIG. 12 is an illustration of the assembly of the resulting product as described with respect to FIG. 11B, in accordance with an embodiment of the present disclosure. At cycle one 200, the low term of value 184 A₀B₀ may be produced. At cycle two 202, the product (A₁+A₀)(B₀+B₁) may be produced. The low term of value 184 (A₀B₀) is subtracted from (A₁+A₀)(B₀+B₁) at the additional subtraction operation 185 to produce value 204 (note that these terms are aligned for this subtraction). As mentioned above, and shown in FIG. 12, the low part of A₀B₀ (200) may shift down to produce one-fourth of the resulting product of the output 186. In cycle three 206, the final term A₁B₁ may be produced. The final term A₁B₁ may be subtracted using a subtractor 207 from (A₁+A₀) (B₀+B₁)−A₀B₀ (note that these terms are aligned in this subtraction). Finally, A₁B₁ is concatenated to the left of the high part of A₀B₀ to create one of the two inputs of the additional addition operation 185. The second input to the additional addition operation 185 is the difference computed by the subtractor 207. The additional addition operation 185 may output three-fourths of the product 186.

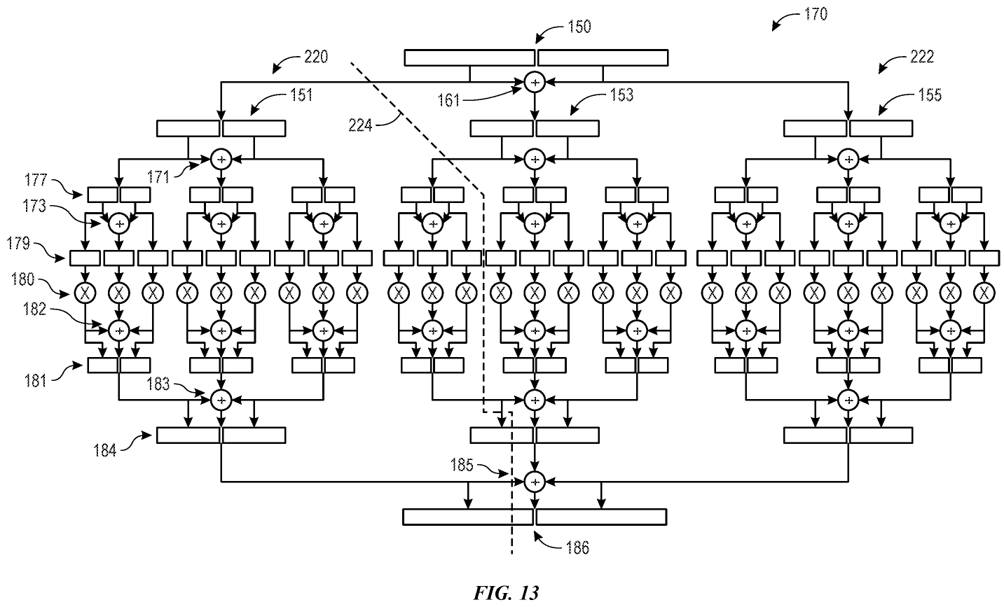

FIG. 13 is a block diagram of a two-cycle three-level decomposition of the multiplier 170. As illustrated, the multiplier 170 has a cut-point 224 in proximity to the middle, resulting in a left portion 220 and a right portion 222.

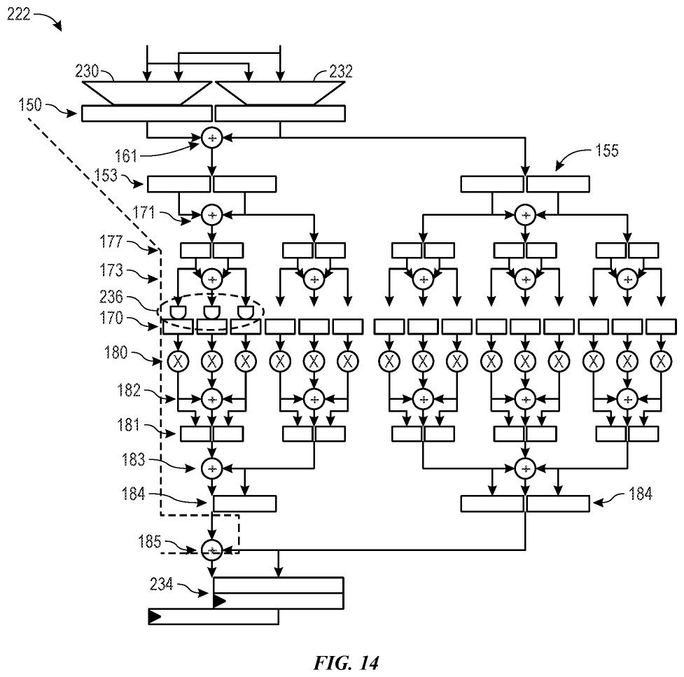

FIG. 14 is a block diagram of the hardware that allows implementing the two-cycle three-level multiplier decomposition according to the cut-point 224. Referring now to FIG. 14, and discussing the execution at high-level, we note that at cycle one, the low term A₀B₀ may be produced as well as a portion of the middle term (A₁+A₀)(B₀+B₁). Further, at cycle two the remaining part of the middle term together with the high term A₁B₁ may be produced. Once the remaining part of the middle product is produced, the full computation of the term (A₁+A₀)(B₀+B₁)−A₀B₀−A₁B₁ may begin (middle term in Equation 7). When the full computation of the middle term is completed, one final addition operation may be used to add the a term formed by concatenating the high-product to the high part of the low product, and the freshly computed term (A₁+A₀)(B₀+B₁)−A₀B₀−A₁B₁ to produce the upper 3/4 of the product. The lower 1/4 of the product may correspond to the low half of the low product A₀B₀.

At cycle one, inputs A and B may be received at the inputs of multiplexers (e.g., selection circuitry) 230 and 232 and may be forwarded into inputs 150. The addition operation 161 produces the two sums A₁+A₀ and B₁+B₀ while the inputs 155 receive the low parts of both inputs A₀ and B₀. The outputs 184 will contain the product A₀B₀. Outputs 181 will contain the low and middle terms of the middle product (A₁+A₀) (B₁+B₀), which will be stored in registers. At cycle two, the input multiplexers 230 and 232 will flip the halves of A and B so that inputs 155 will receive A₁B₁ and inputs 155 will receive the sums (A₀+A₁) and (B₀+B₁). The inputs 155 will also flip these inputs in a similar fashion, such that the high-part of the middle product can now be scheduled on the right part of the middle multiplier. The inputs to the middle multiplier are zeroed using AND gates 236. After computing the high part of the middle multiplier, the additional addition operation 183 can now proceed to compute the middle product 184 (A₀+A₁) and (B₀+B₁). Moreover, the additional addition operation 185 may be used to sum the registered product A₀B₀ with the freshly computed A₁B₁ and the middle product.

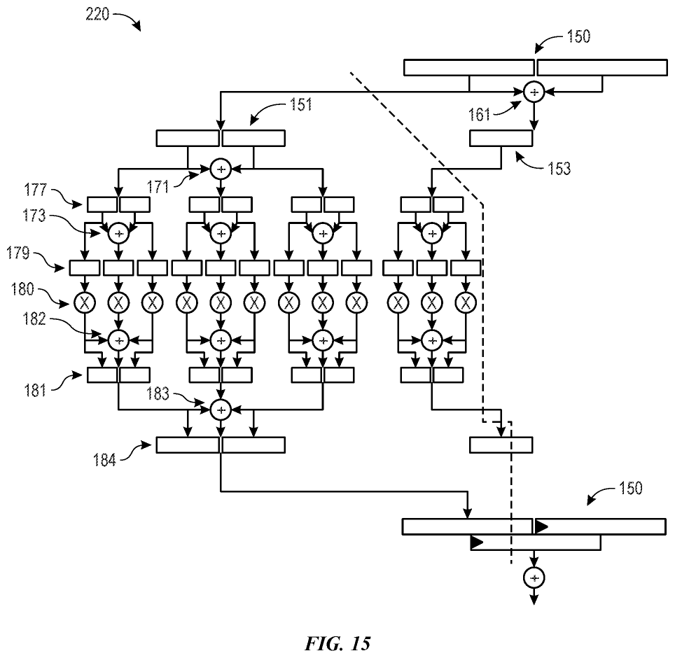

FIG. 15 shows the logical part of the compute separation associated with the split 224 of FIG. 13.

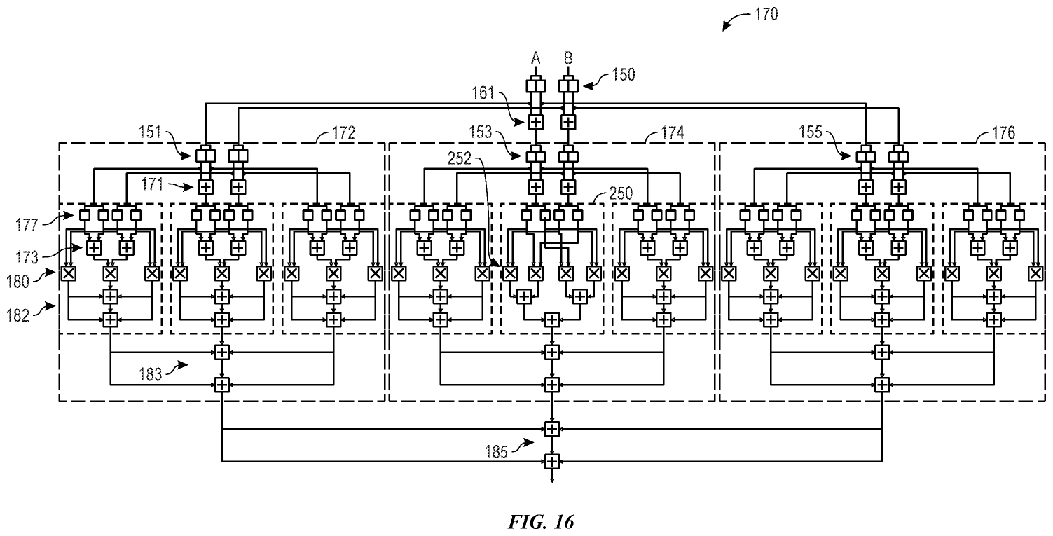

FIG. 16 is an additional embodiment of the multiplier 170 of FIG. 10. As shown in FIG. 16, the two-cycle three level decomposition of the multiplier 170 may include a middle multiplier 250, which may operate using a traditional schoolbook method. It should be noted that although the middle multiplier 250 is operating using the traditional schoolbook method, the rest of the multiplier 170 may still operate using the Karatsuba method. In contrast to the Karatsuba method disclosed above, the schoolbook method may operate by decomposing each operand into two parts and performing four partial products instead of three partial products. The schoolbook method may operate using four multipliers 252 and three addition and/or subtraction operations. Let P_{AL} and P_{BL} be degree 1 polynomials having the product P_{AL}P_{BL} that is a degree 2 polynomial. The product polynomial for the traditional schoolbook method has coefficients according to Equation 8 below:

P_{AL}P_{BL}=(A₁X+B₀)(B₁X+B₀)=A₁B₁X²+X(A₁B₀+A₀B₁)+A₀B₀ Equation 8

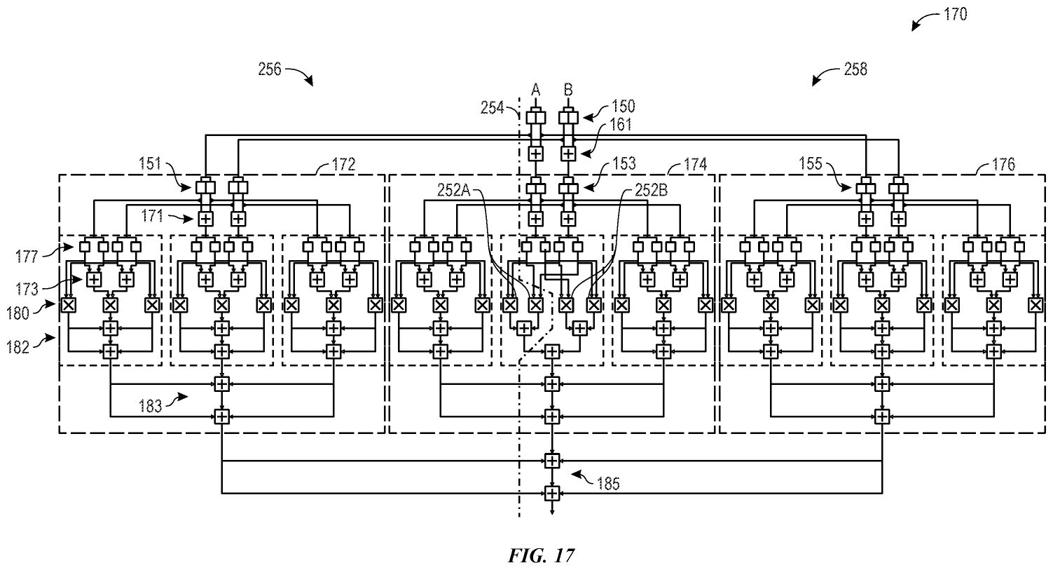

FIG. 17 is a block diagram of a cut point in the additional embodiment of the multiplier 170 of FIG. 10. As illustrated, the multiplier 170 has a cut point 254, which may cut the four multiplication operations 252 to two multiplication operations 252A and two multiplication operations 252B. As mentioned above, the middle multiplier 250 may implement the schoolbook method. Moreover, the multiplier 170 may be split into a first portion 256 and a second portion 258.

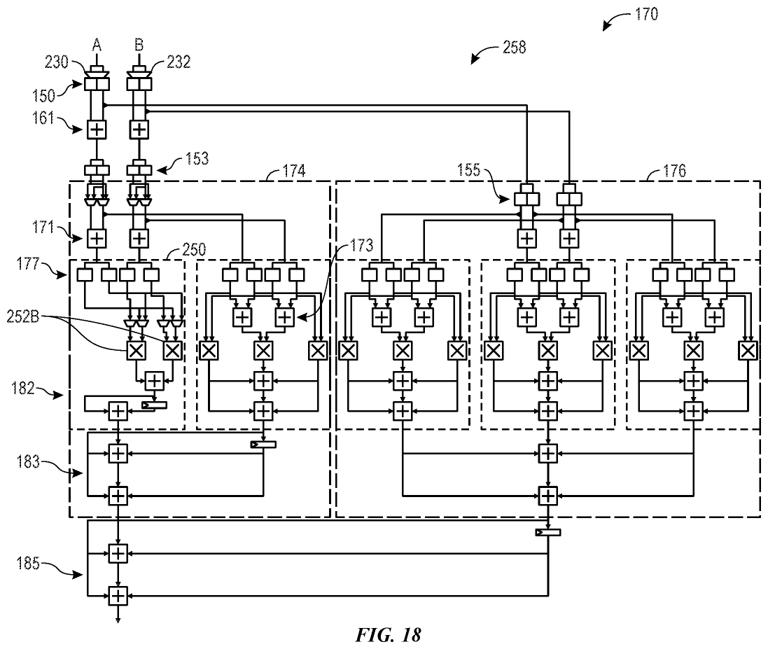

FIG. 18 is a block diagram of the execution kernel multiplier of the additional embodiment of the multiplier 170 of FIG. 10. As shown, one fewer execution kernel multiplier may be used as opposed to the previously depicted approach in FIG. 13. It should be noted that like numerals described and illustrated in FIG. 18 may operate similarly to the numerals described in FIG. 13.

Turning now to FIG. 18, at cycle one, the inputs A and B may be received at the inputs of the multiplexers 230 and 232 and may be forwarded into the inputs 150. As mentioned above, the addition operation 161 produces the two sums (A₁+A₀) and (B₁+B₀), while the inputs 155 receive the low parts of both inputs A₀ and B₀. At cycle two, the input multiplexers 230 and 232 will flip the halves of A and B so that the inputs 153 will receive the sums (A₀+A₁) and (B₀+B₁), while the inputs 155 receive the high parts of both inputs: A₁ and B₁. The inputs may then be fed into the multipliers 252B of the middle multiplier 250 to output a product using the schoolbook method in accordance with Equation 8 above. The additional addition operation 182 sums the product produced by the multipliers 252B to produce an additional product. The additional addition operation 183 sums the additional product to produce the resulting values 184, which may then be assembled by the additional addition operation 185 to assemble the output 186 of the inputs 150.

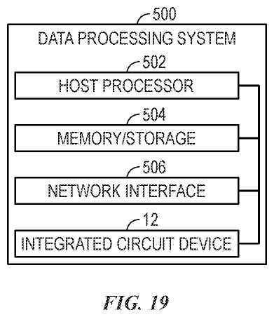

The circuit discussed above may be implemented on the integrated circuit system 12, which may be a component included in a data processing system, such as a data processing system 500, shown in FIG. 19. The data processing system 500 may include the integrated circuit system 12 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 16 may include the integrated circuit system 12 with the programmable routing bridge 84. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. An integrated circuit comprising:

selection circuitry configurable to provide one of a plurality of powers of a hash key;

a Galois field multiplier configurable to receive the one of the plurality of powers of the hash key and a hash sequence and generate one or more values, wherein the Galois field multiplier comprises multiple levels of pipeline stages; and

an adder configurable to receive the one or more values, wherein the adder provides a summation of the one or more values.

EXAMPLE EMBODIMENT 2. The integrated circuit of example embodiment 1, wherein the multiple levels of pipelined stages use a plurality of registers, wherein the plurality of registers operate on different clock cycles.
EXAMPLE EMBODIMENT 3. The integrated circuit of example embodiment 2, wherein the multiple levels of pipelined stages corresponds to the plurality of powers of the hash key.
EXAMPLE EMBODIMENT 4. The integrated circuit of example embodiment 3, wherein a number of the plurality of powers of the hash key is four.
EXAMPLE EMBODIMENT 5. The integrated circuit of example embodiment 4, wherein a number of the multiple levels of pipelined stages is four.
EXAMPLE EMBODIMENT 6. The integrated circuit of example embodiment 1, wherein the Galois field multiplier comprises polynomial multiplication circuitry and modular reduction circuitry.
EXAMPLE EMBODIMENT 7. The integrated circuit of example embodiment 1, wherein each of the multiple levels of pipeline stages stores an independent hash sequence.
EXAMPLE EMBODIMENT 8. The integrated circuit of example embodiment 2, wherein the integrated circuit is implemented in programmable logic and digital signal processing (DSP) blocks of a field programmable gate array.
EXAMPLE EMBODIMENT 9. The integrated circuit of example embodiment 8, wherein the DSP blocks of the field programmable gate array comprises the plurality of registers.
EXAMPLE EMBODIMENT 10. A method comprising:

decomposing a hash sequence, wherein the hash sequence is decomposed into a sum of multiple independent hash sequences;

iteratively performing Galois field multiplication operations using integrated circuitry over a plurality of iterations on each of the multiple independent hash sequences;

after a first of the plurality of iterations has completed, storing a first output of the first of the plurality of iterations in a first pipeline stage;

after a second of the plurality of iterations has completed, storing a second output of the second of the plurality of iterations in the first pipeline stage, wherein the first output transitions to a second pipeline stage;

performing addition operations on the first output and the second output.

EXAMPLE EMBODIMENT 11. The method of example embodiment 10, wherein iteratively performing the Galois field multiplication operations is carried out using programmable logic and digital signal processing (DSP) blocks of a field programmable gate array.
EXAMPLE EMBODIMENT 12. The method of example embodiment 10, wherein the first pipeline stage uses a first register and the second pipeline stage uses a second register.
EXAMPLE EMBODIMENT 13. The method of example embodiment 10, where a number of iterations of the plurality of iterations is at least four.
EXAMPLE EMBODIMENT 14. The method of example embodiment 13, wherein a number of pipeline stages corresponds to a number of multiple independent hash sequences.
EXAMPLE EMBODIMENT 15. Circuitry comprising:

selection circuitry configurable to provide a first input and a second input in a first order during a first cycle and provide the first input and the second input in a second order during a second cycle; and

multiplier circuitry configurable to generate a plurality of subproducts by multiplying the first input and the second input according to the order in which they are provided by the selection circuitry, wherein the multiplier circuitry is configurable to receive the first input and the second input in the first order and perform a first plurality of multiplication operations in the first cycle, and wherein the multiplier circuitry is configurable to receive the first input and the second input in the second order and perform a second plurality of multiplication operations in the second cycle.

EXAMPLE EMBODIMENT 16. The circuitry of example embodiment 15, wherein the multiplier circuitry implements a Karatsuba-Ofman algorithm for performing multiplication.
EXAMPLE EMBODIMENT 17. The circuitry of example embodiment 16, wherein the multiplier circuitry comprises a plurality of stages and a plurality of AND gates to zero inputs to a middle stage of the plurality of stages.
EXAMPLE EMBODIMENT 18. The circuitry of example embodiment 15, wherein the multiplier circuitry implements a schoolbook method algorithm for performing multiplication.
EXAMPLE EMBODIMENT 19. The circuitry of example embodiment 15, wherein a first product of the first cycle and a second product of the second cycle are summed together to obtain a final product.
EXAMPLE EMBODIMENT 20. The circuitry of example embodiment 15, wherein the multiplier circuitry is implemented using programmable logic and digital signal processing (DSP) blocks of a field programmable gate array.

What is claimed is:

1. An integrated circuit comprising:
selection circuitry configurable to provide one of a plurality of powers of a hash key;
a Galois field multiplier configurable to receive the one of the plurality of powers of the hash key and a hash sequence and generate one or more values, wherein the Galois field multiplier comprises multiple levels of pipeline stages; and
an adder configurable to receive the one or more values, wherein the adder provides a summation of the one or more values.

2. The integrated circuit of claim 1, wherein the multiple levels of pipelined stages use a plurality of registers, wherein the plurality of registers operate on different clock cycles.

3. The integrated circuit of claim 2, wherein the multiple levels of pipelined stages corresponds to the plurality of powers of the hash key.

4. The integrated circuit of claim 3, wherein a number of the plurality of powers of the hash key is four.

5. The integrated circuit of claim 4, wherein a number of the multiple levels of pipelined stages is four.

6. The integrated circuit of claim 1, wherein the Galois field multiplier comprises polynomial multiplication circuitry and modular reduction circuitry.

7. The integrated circuit of claim 1, wherein each of the multiple levels of pipeline stages stores an independent hash sequence.

8. The integrated circuit of claim 2, wherein the integrated circuit is implemented in programmable logic and digital signal processing (DSP) blocks of a field programmable gate array.

9. The integrated circuit of claim 8, wherein the DSP blocks of the field programmable gate array comprises the plurality of registers.

10. A method comprising:
decomposing a hash sequence, wherein the hash sequence is decomposed into a sum of multiple independent hash sequences;
iteratively performing Galois field multiplication operations using integrated circuitry over a plurality of iterations on each of the multiple independent hash sequences;
after a first of the plurality of iterations has completed, storing a first output of the first of the plurality of iterations in a first pipeline stage;
after a second of the plurality of iterations has completed, storing a second output of the second of the plurality of iterations in the first pipeline stage, wherein the first output transitions to a second pipeline stage;
performing addition operations on the first output and the second output.

11. The method of claim 10, wherein iteratively performing the Galois field multiplication operations is carried out using programmable logic and digital signal processing (DSP) blocks of a field programmable gate array.

12. The method of claim 10, wherein the first pipeline stage uses a first register and the second pipeline stage uses a second register.

13. The method of claim 10, where a number of iterations of the plurality of iterations is at least four.

14. The method of claim 13, wherein a number of pipeline stages corresponds to a number of multiple independent hash sequences.

15. Circuitry comprising:
selection circuitry configurable to provide a first input and a second input in a first order during a first cycle and provide the first input and the second input in a second order during a second cycle; and
multiplier circuitry configurable to generate a plurality of subproducts by multiplying the first input and the second input according to the order in which they are provided by the selection circuitry, wherein the multiplier circuitry is configurable to receive the first input and the second input in the first order and perform a first plurality of multiplication operations in the first cycle, and wherein the multiplier circuitry is configurable to receive the first input and the second input in the second order and perform a second plurality of multiplication operations in the second cycle.

16. The circuitry of claim 15, wherein the multiplier circuitry implements a Karatsuba-Ofman algorithm for performing multiplication.

17. The circuitry of claim 16, wherein the multiplier circuitry comprises a plurality of stages and a plurality of AND gates to zero inputs to a middle stage of the plurality of stages.

18. The circuitry of claim 15, wherein the multiplier circuitry implements a schoolbook method algorithm for performing multiplication.

19. The circuitry of claim 15, wherein a first product of the first cycle and a second product of the second cycle are summed together to obtain a final product.

20. The circuitry of claim 15, wherein the multiplier circuitry is implemented using programmable logic and digital signal processing (DSP) blocks of a field programmable gate array.
